(19) United States
(12) Patent Application Publication
(10) Pub. No.: US 2014/0216777 A1
(43) Pub. Date: Aug. 7, 2014

(54) BATON-SHAPED HAND-HELD POWER TOOL HAVING A SLIDING SWITCH FOR SWITCHING A DRIVE MOTOR ON AND OFF

(71) Applicant: Robert Bosch GmbH, Stuttgart (DE)

(72) Inventors: Ferdinand Emch, Brugglen (CH); Aldo Di Nicolantonio, Recherswil (CH)

(73) Assignee: Robert Bosch GmbH, Stuttgart (DE)

(21) Appl. No.: 14/174,323

(22) Filed: Feb. 6, 2014

(30) Foreign Application Priority Data
Feb. 6, 2013 (DE) 10 2013 201 942.4
Feb. 4, 2014 (DE) 10 2014 201 918.4

(51) Int. Cl. B25F 5/00

(52) U.S. Cl. CPC B25F 5/00
USPC 173/170

(57) ABSTRACT

A hand-held power tool includes a housing and a sliding switch. A drive motor configured to drive an associated tool insert is arranged in the housing. The sliding switch is configured to switch the drive motor on and off. The sliding switch is configured to assume a multiplicity of operating positions. A rotational speed of the drive motor is varied by varying the operating position of the sliding switch.

This application claims priority under 35 U.S.C. §119 to patent application numbers DE 10 2013 201 942.4, filed on Feb. 6, 2013 in Germany and DE 10 2014 201 918.4, filed on Feb. 4, 2014 in Germany, the disclosures of which are incorporated herein by reference in their entireties.

### BACKGROUND

The present disclosure relates to a baton-shaped hand-held power tool having a housing in which a drive motor for driving an associated tool insert is arranged, and having a sliding switch for switching the drive motor on and off.

The prior art discloses a hand-held power tool of said type having a drive motor, said hand-held power tool being provided for example for the machining of wood and metal and being of so-called baton type of construction, where handling is performed in a longitudinal direction of the drive motor. Said hand-held power tool has an on-and-off switch which is arranged on the side or on the top of the power tool and which can be actuated by a user in a vertical or horizontal direction by means of a slider. Furthermore, said hand-held power tool is equipped with, for example, continuously variable rotational speed regulation of the drive motor in order to permit an optimum adaptation of the motor rotational speed to a respective material to be machined and/or to the tool insert that is respectively in use. A corresponding rotational speed adjustment is normally performed by means of a control wheel that can be rotated by the user.

A disadvantage of the prior art is that, in the case of a hand-held power tool of said type, one hand of a user is required to actuate the control wheel, which is customarily arranged on the rear side of the housing, for rotational speed regulation, such that during the rotational speed adjustment, the user must hold the machine with one hand. Thus, during the operation of the hand-held power tool, safe and precise guidance of the machine using both hands is not possible during a rotational speed adjustment.

### SUMMARY

It is therefore an object of the disclosure to specify a novel hand-held power tool of so-called baton type of construction, wherein it is no longer necessary for a user to adjust their grip in order to perform rotational speed regulation of the drive motor, such that the user can guide always guide the machine safely with both hands in all working situations.

Said problem is solved by means of a baton-shaped hand-held power tool having a housing in which a drive motor for driving an associated tool insert is arranged, and having a sliding switch for switching the drive motor on and off. The sliding switch can assume a multiplicity of operating positions, wherein, by means of a variation of the operating position of the sliding switch, the rotational speed of the drive motor can be varied such that the rotational speed can be adjusted between a zero value, at least one intermediate value and a maximum value.

The disclosure thus permits the provision of a hand-held power tool of so-called baton type of construction, wherein particularly ergonomic rotational speed regulation of the drive motor is provided without the need for the user to adjust their grip. This permits comfortable and safe operation of the hand-held power tool because the rotational speed regulation is also performed directly by means of the sliding switch which otherwise serves for switching the drive motor on and off. A variation of the operating position of the sliding switch corresponds to a displacement of the sliding switch. It is preferable for the sliding switch to be capable of assuming a multiplicity of intermediate positions. In this case, an intermediate position corresponds to an intermediate value of the rotational speed between the zero value and the maximum value of the rotational speed that can be set over the sliding travel of the sliding switch. It is no longer necessary for the user to adjust their grip, which is impractical and detrimental to working safety, in order to perform a rotational speed adjustment, such that the machine can always be guided with both hands. Furthermore, the relatively long sliding travel of the sliding switch permits a sensitive and differentiated rotational speed adjustment.

It is preferably the case that, upon the attainment of the zero value and of the maximum value of the rotational speed, the sliding switch is in a respectively associated end position.

In this way, when the zero-value rotational speed and/or the maximum rotational speed of the drive motor is reached, there is feedback which is haptically intuitively perceptible to the user. Here, the zero-value rotational speed corresponds to an off position of the tool. The maximum rotational speed corresponds to the maximum rotational speed of the drive motor that can be attained over the sliding travel of the sliding switch.

The sliding switch is preferably mounted on the housing so as to be displaceable parallel to or transversely with respect to a longitudinal central axis of the housing.

The parallel or right-angled arrangement of the sliding switch in relation to the longitudinal central axis of the housing permits an adaptation to the requirements of different hand-held power tools, such as for example jigsaws, multi-cutters, angle grinders, reciprocating saws, plate shears, mixers or the like.

It is preferably the case that, by means of the displacement of the sliding switch, the rotational speed can be adjusted between the zero value and the maximum value in continuously variable fashion or, with detent action, in steps.

Here, the sliding switch assumes intermediate positions which correspond to an intermediate value in relation to a zero value and a maximum value of the rotational speed in the end positions of the sliding switch. In this way, the rotational speed of the drive motor of the hand-held power tool and thus also the rotational speed or stroke rate of the tool insert can be optimally adapted to the requirements of the workpiece to be machined and/or of the tool insert that is in use.

In one embodiment, the maximum value of the rotational speed can be predefined at least in two to ten fixed rotational speed steps.

This permits adequately fine presetting of predefined maximum values for the rotational speed of the drive motor of the hand-held power tool. On the housing of the hand-held power tool there may for example be provided a table with recommended rotational speeds for different tool inserts and materials to be machined, in order to make it easier for a user to select the rotational speed for optimum working results.

It is preferably the case that, upon the attainment of the zero value and/or of the maximum value of the rotational speed, the sliding switch locks in a respectively associated end position with detent action.

In this way, the feedback that is haptically intuitively perceptible to the user when the zero-value rotational speed and/or the maximum rotational speed of the drive motor is reached, is intensified. Furthermore, an in particular vibration-induced and/or undesired adjustment of the rotational speed is avoided.

In one embodiment, the maximum value of the rotational speed of the drive motor is predefined by means of a control element, in particular by means of a rotatable control wheel.

This permits precise predefinition and adequately fine setting of the maximum value of the rotational speed of the drive motor. In this way, it is possible in particular for the maximum value of the rotational speed, which corresponds to the end position of the sliding switch, to be varied. In this way, it is possible for maximum rotational speed values to be limited in advance, for example when machining different materials such as for example wood or metal. Said maximum rotational speed values then cannot be exceeded by means of a displacement of the sliding switch. The machining quality can advantageously be increased in this way.

It is preferable for the control element to be mechanically and/or electrically coupled to the rotational speed regulation module of the drive motor.

In this way, it is possible for the maximum rotational speed of the drive motor to be set independently of the position of the sliding switch.

In one embodiment, the sliding switch is mechanically coupled, by means of a coupling element held on the inner side of the housing, in particular by means of a longitudinally displaceable slider, to an electronic rotational speed regulation module which is assigned to the drive motor.

This makes it possible to realize an easy-to-assemble mechanical connection between the sliding switch and the rotational speed regulation module. Furthermore, the coupling element permits spatially more flexible positioning of the individual constituent parts within the housing of the hand-held power tool.

In a further embodiment, on the sliding switch or on the coupling element, there is provided at least one detent element which, at least in the respectively associated end position of the sliding switch, can be locked with detent action to at least one counterpart detent element arranged on the housing.

This provides at least one defined spatial end position of the sliding switch at the zero-value and maximum or highest rotational speeds of the drive motor. It is preferable for a multiplicity of intermediate positions of the sliding switch, which represent rotational speeds of the drive motor between zero and the maximum rotational speed and the switched-on and switched-off states of the drive motor, to be implemented in each case with detent action. The detent and counterpart detent elements may for example be in the form of small projections or lugs which can be placed in engagement with correspondingly formed depressions and thereby locked to the latter with detent action. In particular, it is also possible for the intermediate positions of the sliding switch and also the end positions of the sliding switch to be formed without detent action or of stepless form. In this case, the rotational speed can be increased or decreased in stepless or continuously variable fashion between a zero value in the first end position of the switch and a maximum value in a second end position.

In a further embodiment, the coupling element, in particular in the form of the slider, is displaceably received at least in a groove-like guide on an inner side of the housing.

In this way, the coupling element can be securely guided within the housing. Additional purchase can thereby be provided for a flexible coupling element. A transmission of movement of the sliding switch to the rotational speed regulation module is possible in a precise manner.

It is preferable for the coupling element to have, on an end section facing toward the rotational speed regulation module, a fork-like opening for receiving an actuating pin of the rotational speed regulation module, and an end section, facing toward the sliding switch, of the coupling element has an opening into which a peg formed on the underside of the sliding switch can be locked with detent action in order to create a force-fit connection.

In this way, during the assembly of the housing, it is for example possible for the coupling element to initially be connected to the rotational speed regulation module. After the completion of the assembly of the housing, the peg of the sliding switch is inserted into the opening in the coupling element and thereby locked to the latter with detent action such that, at the same time, the mechanical connection of the sliding switch, which bears against the outside of the housing, to the coupling element, which is situated in the interior of the housing, is realized. For the leadthrough of the peg arranged on the underside of the sliding switch, a preferably rectangular recess of suitable size is provided in the housing of the hand-held power tool.

### BRIEF DESCRIPTION OF THE DRAWINGS

The disclosure is explained in more detail in the following description on the basis of exemplary embodiments illustrated in the drawing, in which:

FIG. 1 shows a schematic perspective view of a hand-held power tool which is in the form of a baton-shaped jigsaw and which has an actuating element formed in the manner of a sliding switch,

FIG. 2 shows a view of a part of the housing of the jigsaw of FIG. 1,

FIG. 3 shows an enlarged view of a detail III of FIG. 2 with an embodiment of a detent arrangement, and

FIG. 4 shows an enlarged view of the slider of FIG. 2 with a further embodiment of a detent arrangement.

### DETAILED DESCRIPTION

FIG. 1 shows a hand-held power tool 10 which, according to one embodiment, is in the form of a battery-driven, baton-shaped jigsaw 12 or configured as a so-called “reciprocating saw”. The jigsaw 12 is in this case configured primarily for use in the DIY sector, though may likewise be used in the industrial sector. It is however pointed out that the present disclosure is not restricted to jigsaws and is also not restricted to such specific embodiments of jigsaws, but may also be used in the case of other, preferably electrically and preferably battery-driven hand-held power tools, such as for example multi-cutters, angle grinders, jigsaws, plate shears, mixers etc., in the case of which handling is not performed in the longitudinal direction of an associated drive motor or tool insert.

The jigsaw 12 comprises, for example, an at least approximately cylindrical housing 14 in which there is arranged at least one preferably electric drive motor 16 with a gearing 18 assigned thereto. By means of the gearing 18, a tool insert 20, which in this case is for example a saw blade 22, can be set in an oscillating sawing motion at least parallel or coaxially with respect to a longitudinal central axis 24 of the housing 14. Furthermore, in order to increase corresponding cutting performance, the linearly oscillating sawing movement of the saw blade 22, as indicated by a double arrow, may if appropriate have superposed thereon a pendular movement transversely with respect to the longitudinal central axis 24, such that the saw blade 22 performs a complex pendular reciprocating movement as a result.

A front section 26 of the housing 14 which faces toward the saw blade 20 has, in the illustration, a larger diameter than the rest of the housing 14. On a rear section 28, facing away from said front section, of the housing 24 there is arranged a battery pack 30 which serves for providing a supply of electrical energy to the drive motor 16, independently of a mains power supply. Alternatively or in addition, the electric drive motor 16 may also be configured such that it can be operated from the mains power supply. Owing to the baton type of construction of the jigsaw 12 shown by way of example in FIG. 1, a drive axis 32 of the drive motor 16 runs approximately parallel to the longitudinal central axis 24, though said drive axis may if appropriate also coincide with said longitudinal central axis. The battery pack 30 can be easily and quickly detached from and reconnected to the housing 14 as required, for example in order to enable the battery pack 30 to be charged, independently of the appliance, in an external charging station, or in order to permit a simple battery pack exchange.

In one embodiment, an actuating element 34, which in this case is realized by way of example with a sliding switch 36, is mounted on the housing 14 so as to be displaceable parallel to the longitudinal central axis 24. The sliding switch 36 can assume a multiplicity of operating positions parallel to the longitudinal central axis 24 in the directions of a double arrow 38, wherein it is preferably possible for the rotational speed of the drive motor 16 to be varied between zero and a maximum value by displacing the sliding switch 36. This means that a user can switch the drive motor 16 on and off by means of the sliding switch 36, and furthermore, the rotational speed of the drive motor 16 can also be varied in stepless fashion, or, with detent action, in steps, up to the maximum rotational speed. In this way, it is not necessary for the user to adjust their grip, which is impractical, in order to perform rotational speed regulation of the jigsaw 12, whereby in particular operating comfort and working safety are increased.

Alternatively, the sliding switch 36 may also be arranged transversely, that is to say at an angle of greater than 0° and, in the illustration, at an angle of 90°, with respect to the longitudinal central axis 24 in the housing 14, as indicated by dotted lines, wherein the switching of the drive motor 16 on and off, and the rotational speed regulation thereof, are realized by means of the displacement of the sliding switch 36 in the direction of an arrow 40 transversely with respect to the longitudinal central axis 24. To permit the rotational speed regulation of the drive motor 16, there is also integrated into the housing 14 an electronic rotational speed regulation module 42 which mechanically interacts with the sliding switch 36 by means of a coupling element 44, which is preferably in the form of a slider 46. The slider 46, the housing 14 and the sliding switch are preferably formed with a thermoplastic or thermosetting plastics material, which if appropriate includes fiber reinforcement in order to increase mechanical strength.

Furthermore, in the housing 14, there is arranged a control element 48, which in this case is for example in the form of a rotatable control wheel 50, for enabling the maximum rotational speed of the drive motor 16 that can be set by displacement of the sliding switch 36 to be predefined or limited in two to ten fixed steps. The control wheel 50 is suitably mechanically and/or electrically coupled, for example by means of electrical lines or a shaft, to the rotational speed regulation module 42 of the drive motor 16. Use may also be made of other coupling types, such as for example magnetic, optical, capacitive, inductive etc.

The sliding switch 36 preferably locks with detent action at least in a forward end position 52 in which the maximum rotational speed of the drive motor 16 is attained, such that an undesired, in particular vibration-induced rotational speed adjustment is prevented. Furthermore, the sliding switch 36 preferably locks with detent action in its rearward end position 54 in which the rotational speed of the drive motor 16 is zero or the drive motor 16 is fully deactivated, in order in particular to generate feedback, which is haptically intuitively perceptible to a user, when the safe deactivated state of the drive motor 16 is reached. Such feedback may also be realized in some other suitable way, for example visually, audibly or tactilely, for example by means of vibration.

In the position indicated by a solid line in FIG. 1, the sliding switch 36 is situated approximately in its central intermediate position in which the rotational speed of the drive motor 16 is at approximately 50% of the maximum rotational speed that can be predefined by means of the control wheel 50. The end positions 52, 54 including all intermediate positions form the entirety of all of the operating positions that the sliding switch 36 can assume through displacement, wherein the intermediate positions may at least partially be implemented with detent action.

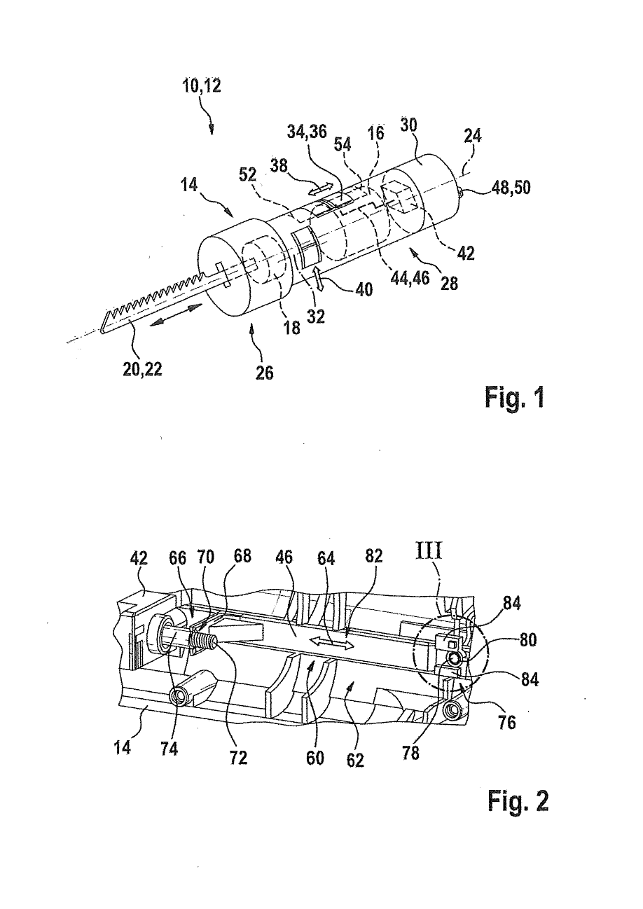

FIG. 2 shows a section of the housing 14 of the jigsaw 12 of FIG. 1 in order to illustrate the mode of operation of the slider 46. Said slider has an at least approximately rectangular cross-sectional geometry and is received, so as to be displaceable parallel to an arrow 64, inter alia in a groove-like guide 60 on an inner side 62 of the housing 14. On a first end section 66, which faces toward the rotational speed regulation module 42, of the slider 46 there is formed an angled portion 68 with a fork-shaped opening 70, in which a slightly conical end section 72 of a cylindrical actuating pin 74 of the rotational speed regulation module 42 is received with a force fit. For this purpose, the conical end section 72 has multiple notches running in each case in a circumferential direction and parallel to one another. Here, the fork-shaped opening 70 points away from the inner side 62 of the housing 14.

On a second end section 76, which faces away from the rotational speed regulation module 42, of the slider 46 there is provided an opening 78 for receiving, with detent action and with a force fit, a peg 80 which is formed on the underside of and integrally with the sliding switch 36 (not visible here) of FIG. 1. The peg 80 is in the form of a spring peg or expansion dowel. The peg 80 which is locked with detent action to the opening 78 completes the force-fit connection between the sliding switch 36 of FIG. 1, the slider 46 and the actuating pin 74 of the rotational speed regulation module 42, whereby any movement of the sliding switch 36 of FIG. 1 is transmitted, ideally without play, to the actuating pin 74 of the rotational speed regulation module 42.

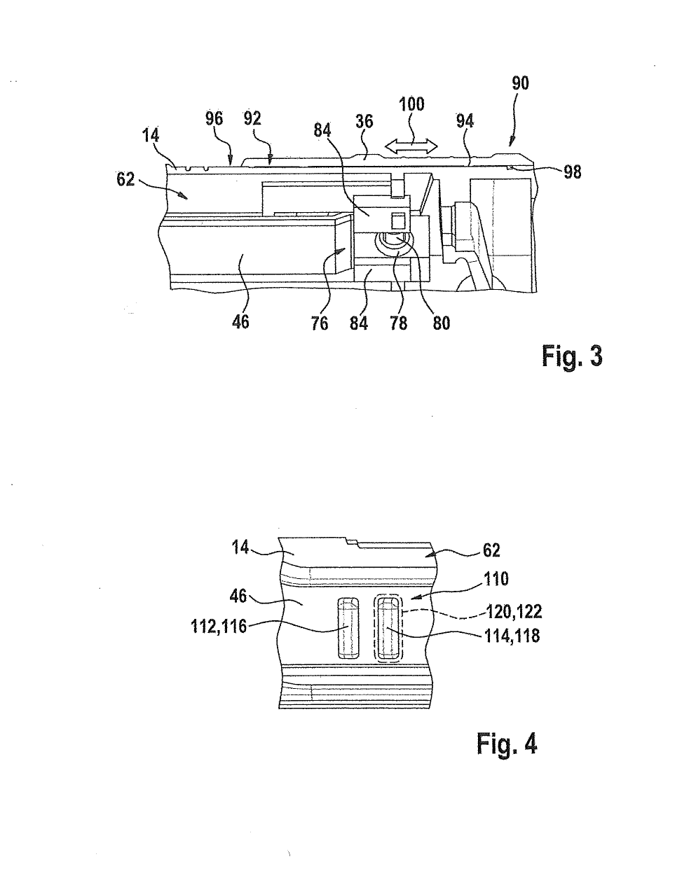

The second end section 76 of the slider 46 is formed with a slight parallel offset (“cranked configuration”) in the direction of the inner side 62 of the housing 14 with respect to a central section 82 of the slider 46, and is received, so as to be longitudinally displaceable parallel to the arrow 64, in a guide 84 formed on the inner side 62 of the housing 14. The guide 84 for receiving the end section 76 in a longitudinally displaceable manner has an approximately C-shaped cross-sectional geometry. By means of the guide 84 and the actuating pin 74, which is inserted into the fork-shaped opening 70, of the rotational speed regulation module 42, the slider 46 is additionally secured in its position without impairment of its axial displaceability parallel with respect to the arrow 64, and in particular cannot lift from the inner side 62 of the housing 14, wherein simple assembly is simultaneously ensured. FIG. 3 shows a detail III from FIG. 2 with the second end section 76, which is received in longitudinally displaceable fashion in the guide 84 on the inner side 62 of the housing 14, of the slider 46 and with a detent arrangement 90 according to the first embodiment. The peg 80 formed on the underside of and integrally with the sliding switch 36 is locked with detent action, so as to form a mechanical connection, to the opening 78 in the second end section 76 of the slider 46.

To achieve locking of the sliding switch 36 with detent action in multiple operating positions, that is to say at least in its two end positions in the deactivated state and at maximum rotational speed of the drive motor, the detent arrangement 90 is provided. Said detent arrangement comprises a multiplicity of detent elements on an underside 92, which faces toward the housing 14, of the sliding switch 36, of which only one detent element 94, as a representative for all others, is provided with a reference numeral. Correspondingly, a multiplicity of counterpart detent elements is formed on an outer side 96 of the housing 14, of which likewise only one counterpart detent element 98, as a representative for the others, is provided with a reference numeral. The detent and counterpart detent elements 94, 98 may for example each be formed with mutually correspondingly formed small projections or lugs and depressions which are in each case formed with a cross-sectional geometry such that they bear against one another with a form fit at least in regions in the state in which they are locked to one another with detent action.

By means of correspondingly positioned detent and counterpart detent elements 94 and 98 respectively, the sliding switch 36, which is longitudinally displaceable in the direction of an arrow 100 in relation to the housing 14, can be reliably locked with detent action in its two end positions and furthermore, if appropriate, in a multiplicity of interposed operating positions with reduced rotational speed of the drive motor 16 of FIG. 1. In the position of the sliding switch 36 illustrated in FIG. 3, said sliding switch is situated between the end positions, that is to say in an operating position without detent locking action.

FIG. 4 shows the slider 46 of FIGS. 2 and 3, which bears against the inner side 62 of the housing 14, and a detent arrangement 110 according to a second embodiment. In the case of the detent arrangement 110, two cuboidal projections 112, 114 which face toward the inner side 62 of the housing 14 are provided on the slider 46, said projections functioning in this case as detent elements 116, 118. The two projections 112, 114 serve for locking, with detent action, to a depression 120 as counterpart detent element 122, said depression being formed correspondingly to the projections 112, 114 on the inner side 62 of the housing 14. Owing to the detent action, it is for example the case that the two end positions of the sliding switch 36 of FIG. 3, in which the drive motor 16 of FIG. 1 respectively runs at maximum rotational speed or is deactivated, are defined with detent action and are haptically intuitively perceptible to a user.

It is pointed out, however, that the two detent arrangements 90 of FIGS. 3 and 110 of FIG. 4 may alternatively or additionally be used for defining, with detent action, the operating positions of the sliding switch 36 of FIG. 3.

What is claimed is:

1. A baton-shaped hand-held power tool, comprising:
a housing in which a drive motor for driving an associated tool insert is arranged; and
a sliding switch configured to switch the drive motor on and off,
wherein the sliding switch is configured to assume a multiplicity of operating positions,
wherein a rotational speed of the drive motor is varied by varying the operating position of the sliding switch such that the rotational speed is adjustable between a zero value, at least one intermediate value and a maximum value.

2. The hand-held power tool according to claim 1, wherein:
upon attainment of the zero value of the rotational speed, the sliding switch is in a first end position, and
upon attainment of the maximum value of the rotational speed, the sliding switch is in a second end position.

3. The hand-held power tool according to claim 1, wherein the sliding switch is mounted on the housing so as to be displaceable parallel to and transversely with respect to a longitudinal central axis of the housing.

4. The hand-held power tool according to claim 1, wherein displacing the sliding switch adjusts the rotational speed between the zero value and the maximum value in one of a continuously variable fashion and, with detent action, steps.

5. The hand-held power tool according to claim 1, wherein the maximum value of the rotational speed is predefined at least in two to ten fixed rotational speed steps.

6. The hand-held power tool according to claim 2, wherein the sliding switch is configured to lock in the first end position with detent action when the rotational speed is at the zero value and is configured to lock in the second end position with detent action when the rotational speed is at the maximum value.

7. The hand-held power tool according to claim 1, wherein the maximum value of the rotational speed of the drive motor is predefined by a control element.

8. The hand-held power tool according to claim 7, wherein the control element is mechanically and/or electrically coupled to a rotational speed regulation module of the drive motor.

9. The hand-held power tool according to claim 2, wherein the sliding switch is mechanically coupled, by a coupling element held on an inner side of the housing, to an electronic rotational speed regulation module which is assigned to the drive motor.

10. The hand-held power tool according to claim 9, further comprising:
at least one detent element on one of the sliding switch and the coupling element,
wherein the at least one detent element, at least in the first end position of the sliding switch, is configured to be locked with detent action to at least one counterpart detent element arranged on the housing.

11. The hand-held power tool according to claim 9, wherein the coupling element is displaceably received at least in a groove-like guide on the inner side of the housing.

12. The hand-held power tool according to claim 9, wherein the coupling element includes:
a first end section facing toward the rotational speed regulation module;
a fork-like opening on the first end section configured to receive an actuating pin of the rotational speed regulation module;
a second end section facing toward the sliding switch; and
an opening on the second end section configured such that a peg formed on an underside of the sliding switch is lockable into the opening with detent action to create a force-fit locking connection.

13. The hand-held power tool according to claim 7, wherein the control element is a rotatable control wheel.

14. The hand-held power tool according to claim 9, wherein the coupling element is a longitudinally displaceable slider.
